(19) United States
(12) Patent Application Publication
(10) Pub. No.: US 2011/0260101 A1
(43) Pub. Date: Oct. 27, 2011

(54) SURFACTANT MIXTURE COMPRISING BRANCHED SHORT-CHAIN AND BRANCHED LONG-CHAIN COMPONENTS

(75) Inventors: Frank Rittig, Worms (DE); Ulrich Steinbrenner, Neustadt (DE); Wolfgang Spiegler, Worms (DE); Michael Stoesser, Neuhofen (DE); Inge Langbein, Frankenthal (DE); Richard Baur, Mutterstadt (DE)

(73) Assignee: BASF SE, Ludwigshafen (DE)

(21) Appl. No.: 13/140,653

(22) PCT Filed: Dec. 18, 2009
(86) PCT No.: PCT/EP2009/067501

§ 371 Date: Jun. 17, 2011

(30) Foreign Application Priority Data
Dec. 18, 2008 (EP) 08172067.4

(51) Int. Cl. C09K 3/00

(52) U.S. Cl. 252/182.12

(57) ABSTRACT

The present invention relates to a surfactant mixture comprising
(A) a short-chain component comprising the alkoxylation product of alkanols, where the alkanols have 8 to 12 carbon atoms and the average number of alkoxy groups per alkanol group in the alkoxylation product assumes a value from 0.1 to 30, the alkoxy groups are C₂₋₁₀-alkoxy groups and the alkanols have an average degree of branching of at least 1; and
(B) a long-chain component comprising the alkoxylation product of alkanols, where the alkanols have 15 to 19 carbon atoms and the average number of alkoxy groups per alkanol group in the alkoxylation product assumes a value from 0.1 to 30, the alkoxy groups are C₂₋₁₀-alkoxy groups and the alkanols have an average degree of branching of at least 2.5;
   and/or phosphate esters, sulfate esters and ether carboxylates thereof. The present invention also relates to formulations comprising such surfactant mixtures, to methods of producing the surfactant mixtures and to their use.

The present invention relates to a surfactant mixture, to formulations comprising such surfactant mixtures, to methods of producing the surfactant mixtures, and to their use.

Surfactants are amphiphilic interface-active compounds which comprise a hydrophobic molecular moiety and also a hydrophilic molecular moiety and, in addition, can have charged or uncharged groups. Surfactants are orientedly absorbed at interfaces and thereby reduce the interfacial tension so that these can form, in solution, association colloids above the critical micelle-formation concentration, meaning that substances which are per se water-insoluble in aqueous solutions are solubilized.

On account of these properties, surfactants are used, for example, for wetting solids such as fibers or hard surfaces. Here, surfactants are often used in combination with one another and also with further auxiliaries. Typical fields of application are detergents and cleaners for textiles and leather, as formulation of paints and coatings and also, for example, in the recovery of petroleum.

Interesting surfactants are in particular those which are alkoxylation products of alcohols. In this connection, it has been found that it is particularly favorable to provide such compounds in various mixtures. Of suitability here are, in particular, mixtures of long-chain and short-chain surfactants.

Such mixtures are described, for example, in WO-A 2007/096292, US-A 2008/103083, DE-A 102 18 752, JP-A 2003/336092 and JP-A 2004/035755.

Furthermore, it is important that, besides their good surfactant properties, surfactants are also readily biodegradable.

Biodegradable surfactants and detergents with readily biodegradable surfactants are described, for example, in WO-A 98/23566.

Higher, branched long-chain alcohol alkoxylates are estimated not to be readily biodegradable.

There is therefore a need, in particular for surfactant mixtures which comprise branched C₁₇-alcohol alkoxylates, for novel surfactant mixtures which have good surfactant properties and are nevertheless readily biodegradable.

An object of the present invention is therefore to provide surfactant mixtures which, from an ecological point of view, allow long-chain components comprising branched C₁₇-alcohol alkoxylates and having good surfactant properties to be used.

The object is achieved by a surfactant mixture comprising
(A) a short-chain component comprising the alkoxylation product of alkanols, where the alkanols have 8 to 12 carbon atoms and the average number of alkoxy groups per alkanol group in the alkoxylation product assumes a value from 0.1 to 30, the alkoxy groups are C₂₋₁₀-alkoxy groups and the alkanols have an average degree of branching of at least 1; and
(B) a long-chain component comprising the alkoxylation product of alkanols, where the alkanols have 15 to 19 carbon atoms and the average number of alkoxy groups per alkanol group in the alkoxylation product assumes a value from 0.1 to 30, the alkoxy groups are C₂₋₁₀-alkoxy groups and the alkanols have an average degree of branching of at least 2.5;
   and/or phosphate esters, sulfate esters and ether carboxylates thereof.

The present invention further provides a formulation comprising the mixture according to the invention.

This is because it has been found that alkoxylation products, comprising long-chain components, of alkanols having 15 to 19 carbon atoms with the degree of branching stated above are readily biodegradable when, in addition, a short-chain component, as stated above, is used in the surfactant mixture.

A further constituent of the object is the development of surfactants which have good detergency. Here too, it was found that the use of long-chain components has a positive effect on the detergency of the surfactant mixture. In particular, the use of branched long-chain hydrophobic building blocks according to the present invention exhibits a surprisingly improved detergency at low temperatures.

Both the short-chain and also the long-chain component can have the alkoxylation products as such or alternatively or additionally their phosphate esters, sulfate esters and ether carboxylates.

The degree of branching of the alkanols (of the alkanol mixture) here is defined as follows:

The degree of branching of an alcohol arises from the branches of the carbon backbone. For each alcohol molecule, it is defined as the number of carbon atoms which are bonded to three further carbon atoms, plus two times the number of carbon atoms which are bonded to four further carbon atoms. The average degree of branching of an alcohol mixture arises from the sum of all degrees of branching of the individual molecules divided by the number of individual molecules. The degree of branching is determined, for example, by means of NMR methods. This can be carried out through analysis of the carbon backbone with suitable coupling methods (COSY, DEPT, INADEQUATE), followed by a quantification via ¹³C NMR with relaxation reagents. However, other NMR methods or GC-MS methods are also possible.

The average number of alkoxy groups arises from the sum of all alkoxy groups of the individual molecules divided by the number of individual molecules.

The surfactant mixture according to the present invention comprises a short-chain component (A) which has the alkoxylation product of branched alkanols, where the alkanols have 8 to 12 carbon atoms. More preferably, the alkanols have 9 to 11 carbon atoms, it being particularly preferred if the alkanols have 10 carbon atoms.

The short-chain component (A) of the surfactant mixture according to the invention can also comprise only one such alkanol, but typically a mixture of such alkanols.

If two or more alkanols are used for the short-chain component (A), in the event that the alkanol has 10 carbon atoms, it is preferred that this mixture is a C₁₀ Guerbet alcohol mixture. Here, the main components are 2-propylheptanol and 5-methyl-2-propylhexanol. Preferably, the short-chain component (A) consists to at least 90%, preferably 95%, of such a mixture.

In addition, it is preferred that the short-chain component comprises no isodecanol.

The degree of alkoxylation of the alkanol(s) for the short-chain component (A) according to the present invention assumes, on average, values of from 0.1 to 30 alkoxy groups per alkanol. Preferably, the value is in the range from 1 to 30 alkoxy groups, more preferably from 3 to 30, more preferably from 3 to 20, more preferably from 4 to 15 and in particular from 5 to 10.

The alkoxy groups are C₂₋₁₀-alkoxy groups, i.e. ethoxy, propoxy, butoxy, pentoxy, hexoxy, heptoxy, octoxy, nonoxy and decoxy groups. However, preference is given to ethoxy, propoxy, butoxy and pentoxy groups. Ethoxy, propoxy and butoxy groups are more preferred. More preferred still are ethoxy and propoxy groups. Particular preference is given to ethoxy groups. It is possible for the alkoxylation to take place in random distribution or blockwise, meaning that the aforementioned alkoxy groups—whether these are different—occur blockwise.

However, it is preferred that the alkoxylation product for the short-chain component (A) has a fraction of ethoxy groups relative to the total number of alkoxy groups which is at least 0.5 for the particular alkoxylation product. More preferably, this is at least 0.75 and it is especially preferred if the alkoxylation product comprises exclusively ethoxy groups as alkoxy groups.

It is preferred if the alkanol mixture of the short-chain component (A) has an average degree of branching of from 1.0 to 2.0. More preferably, the alkanol mixture of the short-chain component (A) has an average degree of branching in the range from 1 to 1.5.

Besides alkoxylation products of branched alkanols which form the short-chain component of the surfactant mixture, it is likewise possible that alkoxylation products of unsaturated aliphatic alcohols are present, in which case these can have the same number of carbon atoms as the alkanols for the short-chain component (A). However, it is preferred if this group of compounds has a weight fraction, based on the total weight of the surfactant mixture, below 10% by weight, preferably less than 5% by weight.

Furthermore, the surfactant mixture can have alkoxylation products, in which case alkanols which do not have the number of carbon atoms stated above form these products. These are in particular alkanols having 1 to 7 carbon atoms, and also alkanols with more than 12 carbon atoms. However, it is preferred if this group of compounds has a weight fraction of at most 10% by weight, preferably of less than 5% by weight, based on the total weight of the surfactant mixture.

Moreover, nonalkoxylated and/or alkoxylation products of branched alkanols which have a higher degree of alkoxylation can arise. In this connection, mention is to be made in particular of a degree of alkoxylation of 31 and more alkoxy groups. It is preferred if this group of compounds has less than 30% by weight, preferably less than 15% by weight, based on the total weight of the surfactant mixture. More preference is given to less than 10% by weight, in particular less than 5% by weight.

Particularly preferred alkoxylate products for the short-chain component (A) are alkoxylates of the general formula (I).

C₅H₁₁CH(C₃H₇)CH₂O(A)ₙ(B)ₘH (I)

where
A is ethyleneoxy
B is C₃₋₁₀-alkyleneoxy, preferably propyleneoxy, butyleneoxy, pentyleneoxy or mixtures thereof,
   where groups A and B may be present in random distribution, alternating or in the form of two or more blocks in any sequence,
n is a number from 0 to 30,
m is a number from 0 to 20
n+m is at least 0.1 and at most 30
   where
70 to 99% by weight of alkoxylates A1, in which C₅H₁₁ has the meaning n-C₅H₁₁, and
1 to 30% by weight of alkoxylates A2, in which C₅H₁₁ has the meaning C₂H₅CH(CH₃)CH₂ and/or CH₃CH(CH₃)CH₂CH₂,
   are present in the mixture.

In the general formula (I), n is preferably a number in the range from 0.1 to 30, in particular from 3 to 12. m is preferably a number in the range from 0 to 8, in particular 1 to 8, particularly preferably 1 to 5. B is preferably propyleneoxy and/or butyleneoxy.

In the alkoxylates according to the invention, it is then possible firstly for propyleneoxy units to be present on the alcohol radical and then ethyleneoxy units. The corresponding alkoxy radicals are preferably present in block form. n and m here refer to a mean value which is the average for the alkoxylates. n and m can therefore also deviate from whole-numbered values. During the alkoxylation of alcohols, a distribution of the degree of alkoxylation is generally obtained which can be adjusted to a certain extent through the use of various alkoxylation catalysts. In the alkoxylate mixtures according to the invention, it is also possible then for firstly ethyleneoxy units to be present on the alcohol radical and then propylene oxy units. In addition, statistical mixtures of ethylene oxide units and propylene oxide units may be present. 3- or multiblock alkoxylation and mixed alkoxylation are also possible. In addition, it is also possible that only ethylene oxide units A or only units B, in particular propylene oxide units, are present. By selecting suitable amounts of groups A and B, the property spectrum of the alkoxylate mixtures according to the invention can be adapted depending on the practical requirements. Particularly preferably, the reaction is firstly carried out with propylene oxide, butylene oxide, pentene oxide or mixtures thereof and then with ethylene oxide. However, it is likewise possible for the reaction to take place with ethylene oxide on its own.

In the general formula (I), B is particularly preferably propyleneoxy. n is then particularly preferably a number from 1 to 20; m is particularly preferably a number from 1 to 8.

The alkoxylate mixtures according to the invention are obtained by alkoxylating the parent alcohols C₅H₁₁CH(C₃H₇)CH₂OH. The starting alcohols can be mixed from the individual components such that the ratio according to the invention arises. They can be prepared by aldol condensation of valeraldehyde and subsequent hydration. The preparation of valeraldehyde and the corresponding isomers takes place by hydroformylation of butene, as described, for example, in U.S. Pat. No. 4,287,370; Beilstein E IV 1, 32 68, Ullmanns Encyclopedia of Industrial Chemistry, 5th edition, vol. A1, pages 323 and 328 f. The subsequent aldol condensation is described, for example, in U.S. Pat. No. 5,434,313 and Römpp, Chemie Lexikon [Chemistry Lexikon], 9th edition, keyword “Aldol addition” page 91. The hydration of the aldol condensation products follow general hydration conditions.

Furthermore, 2-propylheptanol can be prepared by condensing 1-pentanol (as a mixture of the corresponding methylbutanols-1) in the presence of in KOH at elevated temperatures, see e.g. Marcel Guerbet, C. R. Acad Sci Paris 128, 511, 1002 (1899). Furthermore, reference is made to Römpp, Chemie Lexikon [Chemistry Lexikon], 9th edition, Georg Thieme Verlag Stuttgart, and the citations therein, and also Tetrahedron, vol. 23, pages 1723 to 1733.

In the general formula (I), the radical C₅H₁₁ can have the meaning n-C₅H₁₁, C₂H₅CH(CH₃)CH₂ or CH₃CH(CH₃)CH₂CH₂. The alkoxylates are mixtures where

70 to 99% by weight, preferably 85 to 96% by weight, of alkoxylates A1 are present in which C₅H₁₁ has the meaning n-C₅H₁₁, and
1 to 30% by weight, preferably 4 to 15% by weight, of alkoxylates A2 in which C₅H₁₁, has the meaning C₂H₅CH(CH₃)CH₂ and/or CH₃CH(CH₃)CH₂CH₂.

The radical C₃H₇ preferably has the meaning n-C₃H₇.

Preferably, the alkoxylation is catalyzed by strong bases, which are expediently added in the form of an alkali metal alkoholate, alkali metal hydroxide or alkaline earth metal hydroxide, generally in an amount of from 0.1 to 1% by weight, based on the amount of the alkanol R²—OH (cf. G. Gee et al., J. Chem. Soc. (1961), p. 1345; B. Wojtech, Makromol. Chem. 66, (1966), p. 180).

An acidic catalysis of the addition reaction is also possible. Besides Bronsted acids, Lewis acids are also suitable, such as, for example, AlCl₃ or BF₃ dietherate, BF₃, BF₃×H₃PO₄, SbCl₄×2 H₂O, hydrotalcite (cf. P. H. Plesch, The Chemistry of Cationic Polymerization, Pergamon Press, New York (1963)). Suitable catalysts are also double metal cyanide (DMC) compounds.

DMC compounds which can be used are in principle all suitable compounds known to the person skilled in the art.

DMC compounds suitable as catalyst are described in WO-A 03/091192.

The DMC compounds can be used as powder, paste or suspension or be molded to give a molding, be introduced into moldings, foams or the like or be applied to moldings, foams or the like.

The catalyst concentration used for the alkoxylation, based on the final amount structure, is typically less than 2000 ppm (i.e. mg of catalyst per kg of product), preferably less than 1000 ppm, in particular less than 500 ppm, particularly preferably less than 100 ppm, for example less than 50 ppm or 35 ppm, particularly preferably less than 25 ppm.

The addition reaction is carried out at temperatures of from 90 to 240° C., preferably from 120 to 180° C., in a closed vessel. The alkylene oxide or the mixture of different alkylene oxides is introduced into the mixture of alkanol mixture according to the invention and alkali under the vapor pressure of the alkylene oxide mixture prevailing at the selected reaction temperature. If desired, the alkylene oxide can be diluted up to about 30 to 60% with an inert gas. This affords additional safety against explosion-like polyaddition of the alkylene oxide.

If an alkylene oxide mixture is used, then polyether chains are formed in which the different alkylene oxide building blocks are distributed virtually randomly. Variations in the distribution of the building blocks along the polyether chain arise due to differing reaction rates of the components and can also be achieved arbitrarily by continuously introducing an alkylene oxide mixture of program-controlled composition. If the different alkylene oxides are reacted successively, then polyether chains with a block-type distribution of the alkylene oxide building blocks are obtained.

The length of the polyether chains varies within the reaction product statistically about a mean value, the stoichiometric value essentially arising from the added amount.

Preferred alkoxylate mixtures of the general formula (I) can be obtained according to the invention by reacting alcohols of the general formula C₅H₁₁CH(C₃H₇)CH₂OH firstly with propylene oxide and then with ethylene oxide under alkoxylation conditions or only with ethylene oxide. Suitable alkoxylation conditions are described above and in Nikolaus Schönfeldt, Grenzflächenaktive Äthylenoxid-Addukte [Interface-active ethylene oxide adducts], Wissenschaftliche Verlagsgesellschaft mbH Stuttgart 1984. As a rule, the alkoxylation is carried out without a diluent in the presence of basic catalysts such as KOH. However, the alkoxylation can also be carried out with co-use of a solvent. To prepare these alkoxylate mixtures according to the invention, the alcohols are reacted firstly with a suitable amount of propylene oxide and then with a suitable amount of ethylene oxide, or only with ethylene oxide. In this connection, a polymerization of the alkylene oxide is set in motion which automatically results in a random distribution of homologs whose average value is stated in the present case by n and m.

By virtue of the propoxylation being carried out first, as preferred according to the invention, and only then subsequent ethoxylation, the content of residual alcohol in the alkoxylates can be reduced since propylene oxide is added more evenly onto the alcohol component. In contrast to this, ethylene oxide preferably reacts with ethoxylates, meaning that when initially using ethylene oxide for the reaction with the alkanols, both a broad homolog distribution and also a high content of residual alcohol result. The avoidance of relatively large amounts of residual alcohol present in the product is advantageous especially for odor reasons. The alcohol mixtures used according to the invention generally have an intrinsic odor which can be largely suppressed by complete alkoxylation. Alkoxylates obtained according to customary methods often have an intrinsic odor which is troublesome for many applications.

Surprisingly, it has been found that this effect arises even when using small amounts of propylene oxide, i.e. according to the invention less than 1.5 equivalents, based on the alcohol used, in particular less than 1.2 equivalents, particularly preferably less than 1 equivalent.

The alkoxylate mixtures according to the invention for the short-chain component (A) require only a propylene oxide (PO) block of very short length bonded directly to the alcohol to reduce the residual alcohol content. This is especially very advantageous since the biodegradability of the product decreases with increasing length of the PO block. Alkoxylate mixtures of this type thus permit maximum degrees of freedom when choosing the length of the PO block, the length being limited downwards by the increasing residual alcohol content and upwards by the impairment in the biodegradability. This is particularly advantageous if the PO block is followed by only a short ethylene oxide block.

Within the context of the present invention, it is therefore further preferred that m is an integer or fraction where 0<m≦5, for example 0<m≦2, preferably 0<m≦1.5, particularly preferably 0<m≦1.2, in particular 0<m<1.

Furthermore, the surfactant mixture of the present invention comprises a long-chain component (B) which has the alkoxylation product of alkanols which have an average degree of branching of at least 2.5 and at least 15 to 19 carbon atoms. Preferably, the alkanol mixture of the long-chain component (B) has 16 to 18 carbon atoms and in particular 17 carbon atoms.

The long-chain component (B) can also be the alkoxylation product of a single alkanol, although this typically has two or more such alcohols.

The average degree of alkoxylation of the alkanol mixture for the long-chain component (B) according to the present invention assumes values of from 0.1 to 30 alkoxy groups per alkanol. Preferably, the value is in the range from 1 to 30 alkoxy groups, more preferably from 3 to 30, more preferably from 3 to 20, more preferably from 4 to 15 and in particular from 5 to 10.

It is, however, preferred that the alkoxylation product for the long-chain component (B) has a fraction of ethoxy groups relative to the total number of alkoxy groups which is at least 0.5 for the particular alkoxylation product. More preferably, this is at least 0.75 and it is in particular preferred if the alkoxylation product comprises exclusively ethoxy groups as alkoxy groups.

The alkanol mixture of the long-chain component (B) has an average degree of branching of at least 2.5. Preferably, the average degree of branching is more than 2.5. Further preferably, the average degree of branching is 2.5 to 4.0 or more than 2.5 to 4.0, further preferably 2.8 to 3.7, further preferably 2.9 to 3.6, further preferably 3.0 to 3.5, further preferably 3.05 to 3.4 and for example about 3.1.

Besides alkoxylation products of such alkanols which form the long-chain component (B) of the surfactant mixture, it is likewise possible that alkoxylation products of unsaturated aliphatic alcohols are present, in which case these can have the same number of carbon atoms as the alkanols for the long-chain component (B). However, it is preferred if this group of compounds has a weight fraction, based on the total weight of the surfactant mixture, below 30% by weight, preferably less than 15% by weight. More preferably, the fraction is less than 10% by weight, in particular less than 5% by weight.

Furthermore, the surfactant mixture can have alkoxylation products, where alkanols which do not have the number of carbon atoms stated above form these products. These are in particular alkanols having 1 to 12 carbon atoms and also alkanols having more than 20 carbon atoms. However, it is preferred if this group of compounds has a weight fraction of at most 10% by weight, preferably at most 5% by weight, based on the total weight of the surfactant mixture.

Moreover, alkoxylation products of alkanols can arise with branching of at least 2.5, which are not alkoxylated or have a higher degree of alkoxylation. In this connection, a degree of alkoxylation of 31 and more alkoxy groups in particular should be mentioned. It is preferred if this group of compounds has less than 30% by weight, preferably less than 15% by weight, based on the total weight of the surfactant mixture. More preferably, the fraction is below 10% by weight, in particular below 5% by weight.

Preferably, the ratio of the molar fraction of the short-chain component (A) in the surfactant mixture to the molar fraction of the long-chain component (B) in the surfactant mixture is in the value range from 99:1 to 1:99. More preferably, this range is 95:5 to 25:75, furthermore preferably 90:10 to 50:50, furthermore preferably 80:20 to 50:50 and in particular in the range from 70:30 to 50:50. Preferably, the fraction is greater than 1:1.

The added fraction of components (A) and (B) in relation to the total fraction of the surfactant mixture is preferably in each case at least 50% by weight, more preferably at least 60% by weight, furthermore preferably at least 75% by weight, furthermore preferably 90% by weight, based on the total weight of the surfactant mixture.

Besides the components (A) and (B), the surfactant mixture according to the invention and/or the formulation according to the invention can comprise further surfactants different from components (A) and (B), or further chemical compounds. In this connection, polyalkylene glycols, for example, are mentioned which are, if appropriate, formed or added during the preparation of the mixture or of the formulation. Examples of polyalkylene glycols are polyethylene glycol (PEG), polypropylene glycol (PPG), polybutylene glycol (PBG) and combinations thereof. Particular preference is given to polyethylene glycols. These can have a number-averaged molecular weight up to 12 000 g/mol. The polyalkylene glycols can, for example, have a number-averaged molecular weight of from 200 up to 12 000, from 200 to 3000, from 300 to 2000, from 400 to 2000, from 300 to 1000, from 400 to 1000, from 400 to 800, from 600 to 800 or about 700 g/mol. One example of a chemical structure of polyethylene glycol with a number-averaged molecular weight of about 700 g/mol is:

HOCH₂(CH₂OCH₂)ₓCH₂OH,

where x is a natural number from 9 to 22.

Based on the total weight of the mixture or of the formulation, the fraction of polyalkylene glycols is preferably 6 to 10, further preferably 8 to 10% by weight.

The surfactant mixture of the present invention comprises components (A) and (B) which in each case comprise at least one alkoxylation product of alcohols. The surfactant mixture according to the invention can also further comprise radicals of the unreacted alcohols. However, it is preferred if their fraction has below 15% by weight, particularly preferably below 10% by weight, based on the total weight of the surfactant mixture.

The alkoxylation products can be used as such, or their phosphates, sulfate esters or ether carboxylates (carbonates) are used. These may be neutral or in the form of a salt. Suitable counterions are alkali metal and alkaline earth metal cations or ammonium ions and also alkyl- and alkanol ammonium ions.

The long-chain component (B) particularly preferably comprises the alkoxylation product of branched C₁₇-alkanols of the formula R¹—OH whose average degree of branching is 2.8 to 3.7. Preferably, the degree of branching is 2.9 to 3.6, further preferably 3.01 to 3.5, further preferably 3.05 to 3.4 and further preferably 3.1.

### Provision of the Alcohols R¹—OH Used

The alcohols R¹—OH can in principle be synthesized according to any desired method provided in each case they have the described degree of branching.

Alcohols R¹—OH can be obtained, for example, from a branched C16-olefin by hydroformylation followed by hydration of the resulting aldehyde to give to the alcohol. The procedure for a hydroformylation and also the subsequent hydrogenation is known in principle to the person skilled in the art. The C16-olefins used for this purpose can be prepared by tetramerizing butene.

Preferably, the C₁₇-alcohol mixture can be prepared by
a) providing a hydrocarbon feed material which comprises at least one olefin having 2 to 6 carbon atoms,
b) subjecting the hydrocarbon feed material to an oligomerization over a transition-metal-containing catalyst,
c) subjecting the oligomerization product obtained in step b) to a distillative separation to give an olefin stream enriched in C16-olefins,
d) subjecting the C₁₆-olefin-enriched olefin stream obtained in step c) to a hydroformylation through reaction with carbon monoxide and hydrogen in the presence of a cobalt hydroformylation catalyst and then to a hydrogenation.

### Step a) Provision of a Hydrocarbon Mixture

Suitable olefin feed materials for step a) are in principle all compounds which comprise 2 to 6 carbon atoms and at least one ethylenically unsaturated double bond. Preferably, in step a) an industrially available olefin-containing hydrocarbon mixture is used.

Preferred industrially available olefin mixtures result from hydrocarbon cleavage during the processing of petroleum, for example by catalytic cracking, such as fluid catalytic cracking (FCC), thermocracking or hydrocracking with subsequent dehydration. A preferred industrial olefin mixture is the C₄ cut. C₄ cuts are obtainable, for example, by fluid catalytic cracking or steam cracking of gas oil and/or by steam cracking naphtha. Depending on the composition of the C₄ cut, a distinction is made between the whole C₄ cut (crude C₄ cut), the so-called raffinate I obtained after separating off 1,3-butadiene, and the Raffinate II obtained after separating off isobutene. A further suitable industrial olefin mixture is the C₅ cut obtainable during the cleavage of naphtha. Olefin-containing hydrocarbon mixtures having 4 to 6 carbon atoms suitable for use in step a) can also be obtained by catalytic dehydrogenation of suitable industrially available paraffin mixtures. Thus, for example, the preparation of C₄-olefin mixtures is possible from liquid gases (liquefied petroleum gas, LPG) and liquefiable natural gases (liquefied natural gas, LNG). Besides the LPG fraction, the latter also additionally comprise relatively large amounts of relatively high molecular weight hydrocarbon (light naphtha) and are thus also suitable for producing C₅- and C₆-olefin mixtures. The preparation of olefin-containing hydrocarbon mixtures which comprise monoolefins having 4 to 6 carbon atoms from LPG or LNG streams is possible in accordance with customary methods known to the person skilled in the art which, besides the dehydrogenation, usually also comprise one or more work-up steps. These include, for example, separating off at least some of the saturated hydrocarbons present in the aforementioned olefin feed mixtures. These can, for example, be reused for producing olefin feed materials by cracking and/or dehydrogenation. However, the olefins used in step a) can also comprise a fraction of saturated hydrocarbons which behave inertly toward the oligomerization conditions. The fraction of these saturated components is generally at most 60% by weight, preferably at most 40% by weight, particularly preferably at most 20% by weight, based on the total amount of the olefins and saturated hydrocarbons present in the hydrocarbon feed material.

Preferably, in step a), a hydrocarbon mixture is provided which comprises 20 to 100% by weight of C₄-olefins, 0 to 80% by weight of C₅-olefins, 0 to 60% by weight of C₆-olefins and 0 to 10% by weight of olefins different from the aforementioned olefins, in each case based on the total olefin content.

Preferably, in step a), a hydrocarbon mixture is provided which has a content of linear monoolefins of at least 80% by weight, particularly preferably at least 90% by weight and in particular at least 95% by weight, based on the total olefin content. Here, the linear monoolefins are selected from 1-butene, 2-butene, 1-pentene, 2-pentene, 1-hexene, 2-hexene, 3-hexene and mixtures thereof. To establish the desired degree of branching of the isoalkane mixture, it may be advantageous if the hydrocarbon mixture used in step a) comprises up to 20% by weight, preferably up to 5% by weight, in particular up to 3% by weight, of branched olefins, based on the total olefin content.

Particularly preferably, in step a), a C₄-hydrocarbon mixture is provided.

The butene content, based on 1-butene, 2-butene and isobutene, of the C₄-hydrocarbon mixture provided in step a) is preferably 10 to 100% by weight, particularly preferably 50 to 99% by weight, and in particular 70 to 95% by weight, based on the total olefin content. Preferably, the ratio of 1-butene to 2-butene is in a range from 20:1 to 1:2, in particular about 10:1 to 1:1. Preferably, the C₄-hydrocarbon mixture used in step a) comprises less than 5% by weight, in particular less than 3% by weight, of isobutene.

The provision of the olefin-containing hydrocarbons in step a) can comprise separating off branched olefins. Customary separation processes known from the prior art are suitable; these are based on differing physical properties of linear and branched olefins and/or on differing reactivities which allow selective reactions. Thus, for example, isobutene can be separated off from C₄-olefin mixtures, such as raffinate I, by one of the following methods: molecular sieve separation, fractional distillation, reversible hydration to tert-butanol, acid-catalyzed alcohol addition onto a tertiary ether, e.g. methanol addition to methyl tert-butyl ether (MTBE), irreversible catalyzed oligomerization to di- and triisobutene or irreversible polymerization to polyisobutene. Such methods are described in K. Weissermel, H.-J. Arpe, Industrielle organische Chemie [Industrial Organic Chemistry], 4th edition, pp. 76-81, VCH-Verlagsgesellschaft Weinheim, 1994, to which reference is hereby made in its entirety.

Preferably, in step a), a raffinate II is provided.

A raffinate II suitable for use in the method has, for example, the following composition: 0.5 to 5% by weight of isobutane, 5 to 20% by weight of n-butane, 20 to 40% by weight of trans-2-butene, 10 to 20% by weight of cis-2-butene, 25 to 55% by weight of 1-butene, 0.5 to 5% by weight of isobutene, and trace gases, such as, for example, 1,3-butadiene, propene, propane, cyclopropane, propadiene, methylcyclopropane, vinylacetylene, pentenes, pentanes in the range of in each case at most 1% by weight.

A particularly suitable Raffinate II has the following typical composition: isobutane: 3% by weight, n-butane: 15% by weight, isobutene: 2% by weight, 1-butene: 30% by weight, trans-2-butene: 32% by weight, cis-2-butene: 18% by weight.

If diolefins or alkynes are present in the olefin-rich hydrocarbon mixture, then these can be removed from same prior to the oligomerization to preferably less than 100 ppm. They are preferably removed by selective hydrogenation, e.g. according to EP-81 041 and DE-15 68 542, particularly preferably by a selective hydrogenation to a residual content of below 50 ppm.

Moreover, oxygen-containing compounds, such as alcohols, aldehydes, ketones or ethers are expediently largely removed from the olefin-rich hydrocarbon mixture. For this, the olefin-rich hydrocarbon mixture can advantageously be passed over an absorbent, such as, for example, a molecular sieve, in particular one with a pore diameter of >4 Å to 5 Å. The concentration of oxygen-containing, sulfur-containing, nitrogen-containing and halogen-containing compounds in the olefin-rich hydrocarbon mixture is preferably less than 1 ppm by weight, in particular less than 0.5 ppm by weight.

### Step b) Oligomerization

Within the context of the described production method for C₁₇-alcohols, the term “oligomers” comprises dimers, trimers, tetramers, pentamers and higher products from the degradation reaction of the olefins used. The oligomers are for their part olefinically unsaturated. Through suitable selection of the hydrocarbon feed material used for the oligomerization and of the oligomerization catalyst, as described below, it is possible to obtain an oligomerization product that comprises C₁₆-olefins which can advantageously be further processed to give the C₁₇-alcohol mixture used according to the invention.

For the oligomerization step b), a reaction system can be used which comprises one or more, identical or different reactors. In the simplest case, a single reactor is used for the oligomerization in step b). However, it is also possible to use two or more reactors which each have identical or different mixing characteristics. The individual reactors can optionally be divided one or more times by internals. If two or more reactors form the reaction system, then these can be connected with one another in any desired manner, e.g. in parallel or in series. In a suitable configuration, for example, a reaction system is used which consists of two reactors connected in series.

Suitable pressure-resistant reaction apparatuses for the oligomerization are known to the person skilled in the art. These include the generally customary reactors for gas-solid and gas-liquid reactions, such as, for example, tubular reactors, stirred-tank reactors, gas circulation reactors, bubble columns etc., which can, if appropriate, be divided by internals. Preference is given to using tube-bundle reactors or shaft furnaces. If a heterogeneous catalyst is used for the oligomerization, then this can be arranged in one or more catalyst fixed beds. Here, it is possible to use different catalysts in different reaction zones. However, preference is given to using the same catalysts in all reaction zones.

The temperature during the oligomerization reaction is generally in a range from about 20 to 280° C., preferably from 25 to 200° C., in particular from 30 to 140° C. The pressure during the oligomerization is generally in a range from about 1 to 300 bar, preferably from 5 to 100 bar and in particular from 20 to 70 bar. If the reaction system comprises more than one reactor, then these can have identical or different temperatures and identical or different pressures. Thus, for example, in the second reactor of a reactor cascade, a higher temperature and/or a higher pressure than in the first reactor can be established, e.g. in order to achieve as complete a conversion as possible.

In a special embodiment, the temperature and pressure values used for the oligomerization are chosen such that the olefin-containing feed material is liquid or in the supercritical state.

The reaction in step b) is preferably carried out adiabatically. This term is understood below in the technical sense and not in the physicochemical sense. Thus, the oligomerization reaction generally proceeds exothermally such that the reaction mixture, upon flowing through the reaction system, for example a catalyst bed, experiences a temperature increase. Adiabatic reaction procedure is understood as meaning a procedure in which the amount of heat released in an exothermic reaction is taken up by the reaction mixture in the reactor and no cooling by cooling devices is used. Thus, the heat of reaction is dissipated with the reaction mixture from the reactor, apart from a residual fraction which is released to the surroundings by natural heat conduction and heat radiation from the reactor.

For the oligomerization step b), a transition-metal-containing catalyst is used. These are preferably heterogeneous catalysts. Preferred catalysts for the reaction in step a), which, as is known, bring about a slight oligomer branching, are generally known to the person skilled in the art. These include the catalysts described in Catalysis Today, 6, 329 (1990), in particular pages 336-338, and also those described in DE-A-43 39 713 (=WO-A 95/14647) and DE-A-199 57 173, to which reference is hereby expressly made. A suitable oligomerization method in which the feed stream used for the oligomerization is divided and passed to at least two reaction zones operating at different temperatures is described in EP-A-1 457 475, to which reference is likewise made.

Preference is given to using an oligomerization catalyst which comprises nickel. In this connection, preference is given to heterogeneous catalysts which comprise nickel oxide. The heterogeneous-nickel-comprising catalysts used can have various structures. Of suitability in principle are unsupported catalysts and also supported catalysts. The latter are preferably used. The support materials may be, for example, silica, clay earths, aluminosilicates, aluminosilicates with layer structures and zeolites, such as mordenite, faujasite, zeolite X, zeolite Y and ZSM-5, zirconium oxide which has been treated with acids, or sulfated titanium dioxide. Of particular suitability are precipitated catalysts which are obtainable by mixing aqueous solutions of nickel salts and silicates, e.g. sodium silicate with nickel nitrate, and if appropriate aluminum salts, such as aluminum nitrate, and calcining. Furthermore, it is possible to use catalysts which are obtained by incorporating Ni²⁺ ions through ion exchange into natural or synthetic sheet silicates, such as montmorillonites. Suitable catalysts can also be obtained through impregnation of silica, clay earth or aluminosilicates with aqueous solutions of soluble nickel salts, such as nickel nitrate, nickel sulfate or nickel chloride, and subsequent calcination.

Catalysts comprising nickel oxide are preferred. Particular preference is given to catalysts which consist essentially of NiO, SiO₂, TiO₂ and/or ZrO₂ and also if appropriate Al₂O₃. Most preference is given to a catalyst which comprises, as essential active constituents, 10 to 70% by weight of nickel oxide, 5 to 30% by weight of titanium dioxide and/or zirconium dioxide, 0 to 20% by weight of aluminum oxide and, as remainder, silicon dioxide. Such a catalyst is obtainable through precipitation of the catalyst mass at pH 5 to 9 by adding an aqueous solution comprising nickel nitrate to an alkali metal waterglass solution which comprises titanium dioxide and/or zirconium dioxide, filtration, drying and heating at 350 to 650° C. To produce these catalysts, reference is made specifically to DE-43 39 713. Reference is made, in terms of the entire contents, to the disclosure of this specification and the prior art cited therein.

In a further embodiment, the catalyst used in step b) is a nickel catalyst according to DE-A-199 57 173. This is essentially aluminum oxide which has been supplied with a nickel compound and a sulfur compound. Preferably, in the finished catalyst, the molar ratio of sulfur to nickel is in the range from 0.25:1 to 0.38:1.

The catalyst is preferably present in piece form, e.g. in the form of tablets, e.g. having a diameter of from 2 to 6 mm and a height of from 3 to 5 mm, rings having an external diameter of e.g. 5 to 7 mm, a height of from 2 to 5 mm and a hole diameter of from 2 to 3 mm, or strands of varying length with a diameter of e.g. 1.5 to 5 mm. Such forms are obtained in a manner known per se by tableting or extrusion, mostly using a tableting auxiliary, such as graphite or stearic acid.

Preferably, in step b), a C₄-hydrocarbon mixture is used for the oligomerization and an oligomerization product is obtained which comprises 1 to 25% by weight, preferably 2 to 20% by weight, specifically 3 to 15% by weight, of C₁₆-olefins, based on the total weight of the oligomerization product.

### Step c) Distillation

In one or more separation steps, a C₁₆-olefin fraction is isolated from the reaction discharge of the oligomerization reaction. Distillative separation of the oligomerization product obtained in step b) to give an olefin stream enriched in C₁₆-olefins can be carried out continuously or batchwise (discontinuously).

Suitable distillation devices are the customary apparatuses known to the person skilled in the art. These include, for example, distillation columns, such as plate columns, which if desired can be equipped with internals, valves, sidestream takeoffs, etc., evaporators, such as thin-film evaporators, falling-film evaporators, wiper-blade evaporators, Sambay evaporators etc. and combinations thereof. Preferably, the C₁₆-olefin fraction is isolated by fractional distillation.

The distillation itself can take place in one or more distillation columns coupled together.

The distillation column or the distillation columns used can be realized in a configuration known per se (see e.g. Sattler, Thermische Trennverfahren [Thermal Separating Methods], 2nd edition 1995, Weinheim, p. 135ff; Perry's Chemical Engineers Handbook, 7th edition 1997, New York, section 13). The distillation columns used can comprise separating internals, such as separating trays, e.g. perforated trays, bubble-cap trays or valve trays, structured packings, e.g. sheet-metal and fabric packings, or random beds of packings. In the case of the use of tray columns with downcomers, the downcomer residence time is preferably at least 5 seconds, particularly preferably at least 7 seconds. The specific design and operating data, such as the number of plates required in the column(s) used and the reflux ratio can be determined by a person skilled in the art by known methods.

In a preferred embodiment, a combination of two columns is used for the distillation. In this case, the olefin oligomers having fewer than 16 carbon atoms (i.e. when using a C₄-hydrocarbon mixture the C₈- and C₁₂-oligomers) are removed as top product from the first column. The olefin stream enriched in C₁₆-olefins is produced as top product of the second column. Olefin oligomers with more than 16 carbon atoms (i.e. in the case of the use of a C₄-hydrocarbon mixture the C₂₀-, C₂₄- and higher oligomers), are produced as bottom product of the second column.

Suitable evaporators and condensers are likewise apparatus types known per se. As evaporator, it is possible to use a heatable vessel customary for this purpose or an evaporator with forced circulation, for example a falling-film evaporator. If two distillation columns are used for the distillation, then these can be provided with identical or different evaporators and condensers.

Preferably, the bottom temperatures arising during the distillation are at most 300° C., particularly preferably at most 250° C. To maintain these maximum temperatures, the distillation can if desired be carried out under a suitable vacuum.

Preferably, in step c), an olefin stream enriched in C₁₆-olefin is isolated which has a content of olefins having 16 carbon atoms of at least 95% by weight, particularly preferably at least 98% by weight, in particular at least 99% by weight, based on the total weight of the olefin stream enriched in C₁₆-olefins. Specifically, in step c), an olefin stream enriched in C₁₆-olefins is isolated which consists essentially (i.e. to more than 99.5% by weight) of olefins having 16 carbon atoms.

### Step d) Hydroformylation

To prepare an alcohol mixture, the olefin stream enriched in C₁₆-olefins is hydroformylated and then hydrogenated to C₁₇-alcohols. Here, the preparation of the alcohol mixture can take place in one stage or in two separate reaction steps. An overview of hydroformylation processes and suitable catalysts is given in Beller et al., Journal of Molecular Catalysis A 104 (1995), pp. 17-85.

It is critical for the synthesis of the described alcohol mixture that the hydroformylation takes place in the presence of a cobalt hydroformylation catalyst. The amount of hydroformylation catalyst here is generally 0.001 to 0.5% by weight, calculated as cobalt metal, based on the amount of olefins to be hydroformylated.

The reaction temperature is generally in the range from about 100 to 250° C., preferably 150 to 210° C. The reaction can be carried out at an increased pressure of from about 10 to 650 bar, preferably 25 to 350 bar.

In a suitable embodiment, the hydroformylation takes place in the presence of water; however, it can also be carried out in the absence of water.

Carbon monoxide and hydrogen are usually used in the form of a mixture, the so-called synthesis gas. The composition of the synthesis gas used can vary within a wide range. The molar ratio of carbon monoxide and hydrogen is generally about 2.5:1 to 1:2.5. A preferred ratio is about 1:1.

The hydroformylation-active cobalt catalyst is HCo(CO)₄. The catalyst can be preformed outside of the hydroformylation reactor, e.g. from a cobalt(II) salt in the presence of synthesis gas, and be introduced into the hydroformylation reactor together with the C₁₆-olefins and the synthesis gas. Alternatively, the formation of the catalytically active species from catalyst precursors can only take place under the hydroformylation conditions, i.e. in the reaction zone. Suitable catalyst precursors are cobalt(II) salts, such as cobalt(II) carboxylates, e.g. cobalt(II) formate or cobalt(II) acetate; and also cobalt(II) acetylacetonate or CO₂(CO)₈.

The cobalt catalyst homogeneously dissolved in the reaction medium can be suitably separated off from the hydroformylation product by treating the reaction discharge from the hydroformylation firstly in the presence of an acidic aqueous solution with oxygen or air. Here, the cobalt catalyst is oxidatively destroyed with the formation of cobalt(II) salts. The cobalt(II) salts are water-soluble and can be separated off from the reaction discharge through extraction with water. They can generally be reused for producing a hydroformylation catalyst and returned to the hydroformylation process.

For carrying out the hydroformylation continuously, the procedure may, for example, be as follows: (i) an aqueous cobalt(II) salt solution is brought into close contact with hydrogen and carbon monoxide to form a hydroformylation-active cobalt catalyst; (ii) the aqueous phase comprising the cobalt catalyst is brought into close contact, in a reaction zone, with the olefins and also hydrogen and carbon monoxide, the cobalt catalyst being extracted into the organic phase and the olefins being hydroformylated; and (iii) the discharge from the reaction zone is treated with oxygen, the cobalt catalyst being decomposed to form cobalt(II) salts, the cobalt(II) salts being back-extracted into the aqueous phase and the phases being separated. The aqueous cobalt(II) salt solution is then returned to the process. Suitable cobalt(II) salts are in particular cobalt(II) acetate, cobalt(II) formate and cobalt(II) ethylhexanoate. The formation of the cobalt catalyst, the extraction of the cobalt catalyst into the organic phase and the hydroformylation of the olefins can advantageously take place in one step by bringing the aqueous cobalt(II) salt solution, the olefins and if appropriate the organic solvent and also hydrogen and carbon monoxide into close contact in the reaction zone under hydroformylation conditions, e.g. by means of a mixing nozzle.

The crude aldehydes and/or aldehyde/alcohol mixtures obtained during the hydroformylation can, if desired, be isolated prior to the hydrogenation by customary methods known to the person skilled in the art and, if appropriate, be purified. As a rule, the product mixture obtained after removing the hydroformylation catalyst can be used in the hydrogenation without further work-up.

### Hydrogenation

For the hydrogenation, the reaction mixtures obtained during the hydroformylation are reacted with hydrogen in the presence of a hydrogenation catalyst.

Suitable hydrogenation catalysts are generally transition metals, such as, for example, Cr, Mo, W, Fe, Rh, Co, Ni, Pd, Pt, Ru etc. or mixtures thereof, which, to increase the activity and stability, can be applied to supports, such as, for example, activated carbon, aluminum oxide, kieselguhr etc. To increase the catalytic activity, Fe, Co and preferably Ni, also in the form of the Raney catalysts, can be used as metal sponge with a very large surface area. Preference is given to using a Co/Mo catalyst for producing the surfactant alcohols according to the invention. The hydrogenation of the oxoaldehydes takes place preferably at elevated temperatures and increased pressure depending on the activity of the catalyst. Preferably, the hydrogenation temperature is about 80 to 250° C. Preferably, the pressure is about 50 to 350 mbar.

The reaction mixture obtained after the hydrogenation can be worked-up in accordance with customary purification methods known to the person skilled in the art, in particular by fractional distillation, where a C₁₇-alcohol mixture with the degree of branching described at the start is obtained in pure form.

The C₁₇-alcohol mixture obtained by the described method preferably has a content of alcohols having 17 carbon atoms of at least 95% by weight, particularly preferably at least 98% by weight, in particular at least 99% by weight, based on the total weight of the C₁₇-alcohol mixture. Specifically, it is a C₁₇-alcohol mixture which consists essentially (i.e. to more than 99.5% by weight, specifically to more than 99.9% by weight) of alcohols having 17 carbon atoms.

In this connection, particular preference is given to alkyl alkoxylates (BA) of the general formula (II)

R¹O—(CH₂CH(R²)O)ₘ(CH₂CH₂O)ₙ—H (II).

The alkyl alkoxylates (BA) comprise m alkoxy groups of the general formula —CH₂CH(R²)O— and n ethoxy groups —CH₂CH₂O—. The formula of the alkoxy group here is expressly intended to include units also of the formula —CH(R²)CH₂O—, thus the inverse incorporation of the alkoxy group into the surfactant, where of course also both arrangements may be represented in a surfactant molecule. R² is chosen such that the parent alkoxy group is a C₃₋₁₀-alkoxy group, where a surfactant molecule can also have a plurality of different radicals R². Preferably, R² is a methyl, ethyl and/or n-propyl group, and is particularly preferably a methyl group, i.e. the alkoxy group is a propoxy group.

The numbers n and m refer here, in a known manner, to the average value of the alkoxy and/or ethoxy groups present in the surfactant, where the average value does not of course have to be a natural number, but may also be any desired rational number.

The numbers n and m here have the meaning given for formula (I). In the mixture, however, the values n and m must not be identical for short-chain and long-chain components.

The arrangement of the alkoxy groups and ethoxy groups in the surfactant (II)—where both types of groups are present—can be random or alternating, or a block structure may be present. It is preferably a block structure in which the alkoxy and ethoxy groups are actually arranged in the order R¹O—alkoxy block—ethoxy block-H.

The alkyl alkoxylates (BA) can be prepared in a manner known in principle by alkoxylation of the alcohol R¹—OH. The way in which alkoxylations are carried out is known in principle to the person skilled in the art. It is likewise known to the person skilled in the art that the molecular weight distribution of the alkoxylates can be influenced by the reaction conditions, in particular the choice of catalyst.

The alkyl alkoxylates (BA) can be prepared, for example, by base-catalyzed alkoxylation. For this, the alcohol R¹—OH can be admixed in a pressurized reactor with alkali metal hydroxides, preferably potassium hydroxide or with alkali metal alcoholates, such as, for example, sodium methylate. Through reduced pressure (for example <100 mbar) and/or by increasing the temperature (30 to 150° C.), it is also possible to strip off any water present in the mixture. Afterwards, the alcohol is in the form of the corresponding alcoholate. The system is then rendered inert with inert gas (e.g. nitrogen) and the alkylene oxide(s) are added stepwise at temperatures of from 60 to 180° C. up to a pressure of maximum 10 bar. At the end of the reaction, the catalyst can be neutralized by adding acid (e.g. acetic acid or phosphoric acid) and can, if required, be filtered off. Alkyl alkoxylates prepared by means of KOH catalysis generally have a relatively broad molecular weight distribution.

In one preferred embodiment of the invention, the alkyl alkoxylates (BA) are synthesized using techniques known to the person skilled in the art which lead to narrower molecular weight distributions than in the case of the base-catalyzed synthesis. For this, the catalyst used may be, for example, double hydroxide clays as described in DE 43 25 237 A1. The alkoxylation can particularly preferably take place using double metal cyanide catalysts (DMC catalysts). Suitable DMC catalysts are disclosed, for example, in DE 102 43 361 A1, in particular sections [0029] to [0041] and the literature cited therein. For example, catalysts of the Zn—Co type can be used. To carry out the reaction, alcohol R¹—OH can be admixed with the catalyst, the mixture can be dewatered as described above and reacted with the alkylene oxides as described. Usually, not more than 250 ppm of catalyst with regard to the mixture are used, and the catalyst can remain in the product on account of this low amount. Surfactants according to the invention prepared by means of DMC catalysis are notable for the fact that they result in a better lowering of the interfacial tension in the system water-crude oil, than products prepared by means of KOH catalysis.

Alkyl alkoxylates (BA) can furthermore also be prepared by acid-catalyzed alkoxylation. The acids are Brönstedt acids or Lewis acids. To carry out the reaction, alcohol R¹—OH can be admixed with the catalyst, and the mixture can be dewatered as described above and reacted with the alkylene oxides as described. At the end of the reaction, the catalyst can be neutralized by adding a base, for example KOH or NaOH, and be filtered off if required. The structure of the hydrophilic group X can be influenced by the choice of catalyst. Whereas in the case of basic catalysis the alkoxy units are incorporated predominantly into the alkyl alkoxylate in the orientation shown in formula (Ia), in the case of acidic catalysis the units are incorporated in greater parts in the orientation (Ib).

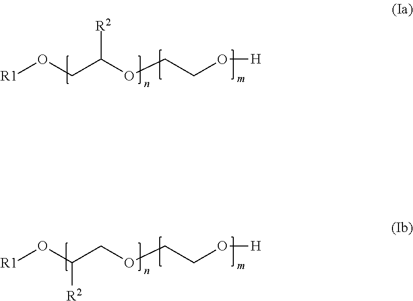

The present invention further provides a formulation comprising a surfactant mixture according to the invention.

The formulation can, for example, comprise 0.01 to 90% by weight of water. Moreover or alternatively, the formulation can have further surfactants or hydrotropes or mixtures thereof. For example, mention may be made here of alcohol alkoxylates of the formula P(O—R-Aoₙ)ₘ—H, where P is a saturated, unsaturated or aromatic carbon backbone to which m alcohol functions are linked which have in turn been etherified with, on average, in each case n alkylene oxide units. n here has a value from 1 to 4 and m a value from 1 to 10. R is an alkylene group having 1 to 10 carbon atoms, Ao is a C₂-C₅-alkylene oxide. Examples thereof are methylethylene glycols, butylethylene glycols, pentylethylene glycols, hexylethylene glycols, butylpropylene glycols, trimethylolpropane ethoxylates, glycerol ethoxylates, pentaerythritol ethoxylates, ethoxylates and propoxylates of bisphenol A.

The present invention further provides a method of producing a surfactant mixture according to the invention, comprising the steps
(a) alkoxylation of an alkanol mixture, where the alkanol mixture has 8 to 12 carbon atoms, the average number of alkoxy groups per alkanol group in the alkoxylation product assumes a value from 0.1 to 30, the alkoxy groups are C₂₋₁₀-alkoxy groups and the alkanol mixture has an average degree of branching of at least 1;
(b) alkoxylation of an alkanol mixture, where the alkanol mixture has 15 to 19 carbon atoms, the average number of alkoxy groups per alkanol group in the alkoxylation product assumes a value from 0.1 to 30, the alkoxy groups are C₂₋₁₀-alkoxy groups and the alkanol mixture has an average degree of branching of at least 2.5; and
(c) mixing the alkoxylation products obtained in step (a) and (b).

It is clear to the person skilled in the art that the degree of alkoxylation can be different.

Besides the method described above for producing a surfactant mixture, the corresponding alkanols for the short-chain component (A) and long-chain component (B) can also be mixed before the alkoxylation and then the mixture can be subjected to an alkoxylation.

Consequently, the present invention further provides a method of producing a surfactant mixture according to the invention, comprising the steps
(a) mixing a first alkanol mixture, which has 8 to 12 carbon atoms and an average degree of branching of at least 1, with at least a second alkanol mixture, which has 15 to 19 carbon atoms and an average degree of branching of at least 2.5; and
(b) alkoxylation of the mixture of the first and second mixture, where the number of alkoxy groups per alkanol group in the alkoxylation product assumes an average value of from 0.1 to 30 and the alkoxy groups are C₂₋₁₀-alkoxy groups.

Furthermore, a method for producing a surfactant mixture according to the invention can comprise the following steps:
(a) alkoxylation of a first alkanol mixture where the number of alkoxy groups per alkanol groups in the alkoxylation product assumes an average value of from 0.1 to 30 and the alkoxy groups are C₂₋₁₀-alkoxy groups;
(b) addition of the second alkanol mixture;
(c) alkoxylation of the mixture from (b), where the number of alkoxy groups per alkanol group in the alkoxylation product assumes an average value from 0.1 to 30 and the alkoxy groups are C₂₋₁₀-alkoxy groups,
   where the first alkanol mixture has 8 to 12 carbon atoms and an average degree of branching of at least 1 and the second alkanol mixture has 15 to 19 carbon atoms and an average degree of branching of at least 2.5, or first and second mixture are swapped.

The order of the addition of the alkanol mixtures can thus be chosen arbitrarily.

The surfactant mixtures or formulations according to the invention can be used, for example, as surfactant formulations for cleaning hard surfaces. Suitable surfactant formulations for which the surfactant mixtures according to the invention can be provided as additives are described, for example, in Formulating Detergents and Personal Care Products by Louis Ho Tan Tai, AOCS Press, 2000.

As further components, they comprise soap, anionic surfactants, such as LAS (linear alkylbenzenesulfonate) or paraffinsulfonates or FAS (fatty alcohol sulfate) or FAES (fatty alcohol ether sulfate), acid, such as phosphoric acid, amidosulfonic acid, citric acid, lactic acid, acetic acid, other organic and inorganic acids, solvents, such as ethylene glycol, isopropanol, complexing agents such as EDTA (N,N,N′,N′-ethylenediaminetetraacetic acid), NTA (N,N,N-nitrilotriacetic acid), MGDA (2-methyl-glycine-N,N-diacetic acid), phosphonates, polymers, such as polyacrylates, copolymers maleic acid-acrylic acid, alkali donors, such as hydroxides, silicates, carbonates, perfume oils, oxidizing agents, such as perborates, peracids or trichloroisocyanuric acid, Na or K dichloroisocyanurates, enzymes; see also Milton J. Rosen, Manilal Dahanayake, Industrial Utilization of Surfactants, AOCS Press, 2000 and Nikolaus Schönfeldt, Grenzflächenaktive Ethylenoxyaddukte [Interface-active ethyleneoxy adducts]. These also discuss formulations for the other specified uses in principle. These may be household cleaners such as all purpose cleaners, dishwashing detergents for manual and automatic dishwashing, metal degreasing, industrial applications, such as cleaners for the food industry, bottle washing, etc. They may also be printed roll and printing plate cleaners in the printing industry. Suitable further ingredients are known to the person skilled in the art.

Uses of a surfactant mixture according to the invention or of a formulation according to the invention are:
Humectants, in particular for the printing industry.
Cosmetic, pharmaceutical and crop protection formulations. Suitable crop protection formulations are described, for example, in EP-A 0 050 228. Further ingredients customary for crop protection compositions may be present.
Paints, coating compositions, dyes, pigment preparations and adhesives in the coatings and polymer film industry.
Leather degreasing compositions.
Formulations for the textile industry, such as leveling agents or formulations for yarn cleaning.
Fiber processing and auxiliaries for the paper and pulp industry.
Metal processing, such as metal finishing and electroplating sector.
Food industry.
Water treatment and production of drinking water.
Fermentation.
Mineral processing and dust control.
Building auxiliaries.
Emulsion polymerization and preparation of dispersions.
Coolants and lubricants.

Such formulations usually comprise ingredients such as surfactants, builders, fragrances and dyes, complexing agents, polymers and other ingredients. Typical formulations are described, for example, in WO 01/32820. Further ingredients suitable for various applications are described in EP-A 0 620 270, WO 95/27034, EP-A 0 681 865, EP-A 0 616 026, EP-A 0 616 028, DE-A 42 37 178 and U.S. Pat. No. 5,340,495 and in Schönfeldt, see above, for example.

In general, the compositions according to the invention can be used in all areas where the effect of interface-active substances is necessary.

The present invention therefore also relates to detergents, cleaners, wetting agents, coatings, adhesives, leather degreasing compositions, humectants or textile treatment compositions or cosmetic, pharmaceutical or crop protection formulations comprising a composition according to the invention or a composition prepared by a method according to the invention. The products here preferably comprise 0.1 to 80% by weight of the compositions.

The customary constituents of the detergents according to the invention, in particular textile detergents, include, for example, builders, surfactants, bleaches, enzymes and further ingredients, as described below.

### Builders

Inorganic builders (A′) suitable for combination with the surfactants according to the invention are primarily crystalline or amorphous alumosilicates with ion-exchanging properties, such as, in particular, zeolites. Various types of zeolites are suitable, in particular zeolites A, X, B, P, MAP and HS in their Na form or in forms in which Na is partially exchanged for other cations such as Li, K, Ca, Mg or ammonium. Suitable zeolites are described, for example, in EP-A 0 038 591, EP-A 0 021 491, EP-A 0 087 035, U.S. Pat. No. 4,604,224, GB-A 2 013 259, EP-A 0 522 726, EP-A 0 384 070 and WO-A 94/24251.

Suitable crystalline silicates (A′) are, for example, disilicates or sheet silicates, e.g. SKS-6 (manufacturer: Hoechst). The silicates can be used in the form of their alkali metal, alkaline earth metal or ammonium salts, preferably as Na, Li and Mg silicates.

Amorphous silicates, such as, for example, sodium metasilicate, which has a polymeric structure, or Britesil® H20 (manufacturer: Akzo) can likewise be used.

Suitable inorganic builder substances based on carbonate are carbonates and hydrogencarbonates. These can be used in the form of their alkali metal, alkaline earth metal or ammonium salts. Preferably, Na, Li and Mg carbonates or hydrogencarbonates, in particular sodium carbonate and/or sodium hydrogencarbonate, are used.

Customary phosphates as inorganic builders are polyphosphates, such as, for example, pentasodium triphosphate.

The specified components (A′) can be used individually or in mixtures with one another. Of particular interest as inorganic builder component is a mixture of aluminosilicates and carbonates, in particular of zeolites, primarily zeolite A, and alkali metal carbonates, primarily sodium carbonate, in the weight ratio 98:2 to 20:80, in particular from 85:15 to 40:60. Besides this mixture, other components (A′) may also be present.

In a preferred embodiment, the textile detergent formulation according to the invention comprises 0.1 to 20% by weight, in particular 1 to 12% by weight, of organic cobuilders (B′) in the form of low molecular weight, oligomeric or polymeric carboxylic acids, in particular polycarboxylic acids, or phosphonic acids or salts thereof, in particular Na or K salts.

Suitable low molecular weight carboxylic acids or phosphonic acids for (B′) are, for example:

C₄-C₂₀-di-, tri- and -tetracarboxylic acids, such as, for example, succinic acid, propanetricarboxylic acid, butanetetracarboxylic acid, cyclopentanetetracarboxylic acid and alkyl- and alkenylsuccinic acids with C₂-C₁₆-alkyl or -alkenyl radicals;
C₄-C₂₀-hydroxycarboxylic acids, such as, for example, maleic acid, tartaric acid, gluconic acid, glutaric acid, citric acid, lactobionic acid and sucrose mono-, di- and tricarboxylic acid;
aminopolycarboxylic acids, such as, for example, nitrilotriacetic acid, β-alaninediacetic acid, ethylenediaminetetraacetic acid, serinediacetic acid, isoserinediacetic acid, methylglycinediacetic acid and alkylethylenediamine triacetates; salts of phosphonic acids, such as, for example, hydroxyethanediphosphonic acid.

Suitable oligomeric or polymeric carboxylic acids for (B′) are, for example:

oligomaleic acids, as are described, for example, in EP-A 451 508 and EP-A 396 303;
co- and terpolymers of unsaturated C₄-C₈-dicarboxylic acids, where the comonomers may be copolymerized monoethylenically unsaturated monomers
from the group (i) in amounts of up to 95% by weight,
from the group (ii) in amounts of up to 60% by weight and
from the group (iii) in amounts of up to 20% by weight.

Suitable unsaturated C₄-C₈-dicarboxylic acids here are, for example, maleic acid, fumaric acid, itaconic acid and citraconic acid. Preference is given to maleic acid.

The group (i) comprises monoethylenically unsaturated C₃-C₈-monocarboxylic acids, such as, for example, acrylic acid, methacrylic acid, crotonic acid and vinylacetic acid. From group (i), preference is given to using acrylic acid and methacrylic acid.

Group (ii) comprises monoethylenically unsaturated C₂-C₂₂-olefins, vinyl alkyl ethers with C₁-C₈-alkyl groups, styrene, vinyl esters of C₁-C₈-carboxylic acids, (meth)acrylamide and vinylpyrrolidone. From group (ii), preference is given to using C₂-C₆-olefins, vinyl alkyl ethers with C₁-C₄-alkyl groups, vinyl acetate and vinyl propionate.

Group (iii) comprises (meth)acrylic esters of C₁-C₈-alcohols, (meth)acrylonitrile, (meth)acrylamides of C₁-C₈-amines, N-vinylformamide and vinylimidazole.

If the polymers of group (ii) comprise vinyl esters in copolymerized form, these may also be present in partially or completely hydrolyzed form to give vinyl alcohol structural units. Suitable copolymers and terpolymers are known, for example, from U.S. Pat. No. 3,887,806 and DE-A 43 13 909.

Suitable copolymers of dicarboxylic acids for (B′) are preferably:

copolymers of maleic acid and acrylic acid in the weight ratio 100:90 to 95:5, particularly preferably those in the weight ratio 30:70 to 90:10 with molar masses from 100 000 to 150 000;
terpolymers of maleic acid, acrylic acid and a vinyl ester of a C₁-C₃-carboxylic acid in the weight ratio 10 (maleic acid):90 (acrylic acid+vinyl ester) to 95 (maleic acid):10 (acrylic acid+vinyl ester), where the weight ratio of acrylic acid to the vinyl ester can vary in the range from 30:70 to 70:30;
copolymers of maleic acid with C₂-C₈-olefins in the molar ratio 40:60 to 80:20, where copolymers of maleic acid with ethylene, propylene or isobutene in the molar ratio 50:50 are particularly preferred.

Graft polymers of unsaturated carboxylic acids based on low molecular weight carbohydrates or hydrogenated carbohydrates, cf. U.S. Pat. No. 5,227,446, DE-A 44 15 623 and DE-A 43 13 909, are likewise suitable as (B′).

Suitable unsaturated carboxylic acids here are, for example, maleic acid, fumaric acid, itaconic acid, citraconic acid, acrylic acid, methacrylic acid, crotonic acid and vinylacetic acid, and mixtures of acrylic acid and maleic acid, which are grafted on in amounts of from 40 to 95% by weight, based on the component to be grafted.

For the modification, additionally up to 30% by weight, based on the component to be grafted, of further monoethylenically unsaturated monomers are present in copolymerized form. Suitable modifying monomers are the abovementioned monomers of groups (ii) and (iii).

Suitable graft bases are degraded polysaccharides, such as, for example, acidically or enzymatically degraded starches, inulins or cellulose, protein hydrolysates and reduced (hydrogenated or reductively aminated) degraded polysaccharides, such as, for example, mannitol, sorbitol, aminosorbitol and N-alkylglucamine, and also polyalkylene glycols with molar masses up to M_{w}=5000, such as, for example, polyethylene glycols, ethylene oxide/propylene oxide or ethylene oxide/butylene oxide or ethylene oxide/propylene oxide/butylene oxide block copolymers and alkoxylated mono- or polyhydric C₁-C₂₂-alcohols, cf. U.S. Pat. No. 5,756,456.

From this group, preference is given to using grafted degraded or degraded reduced starches and grafted polyethylene oxides, where 20 to 80% by weight of monomers, based on the graft component, are used in the graft polymerization. For the grafting, a mixture of maleic acid and acrylic acid in the weight ratio from 90:10 to 10:90 is preferably used.

Polyglyoxylic acids suitable as (B′) are described, for example, in EP-B 001 004, U.S. Pat. No. 5,399,286, DE-A 41 06 355 and EP-A 0 656 914. The end groups of the polyglyoxylic acids can have various structures.

Polyamidocarboxylic acids and modified polyamidocarboxylic acids suitable as (B′) are known, for example, from EP-A 454 126, EP-B 511 037, WO-A 94/01486 and EP-A 581 452.

As (B′), use is made in particular also of polyaspartic acids or cocondensates of aspartic acid with further amino acids, C₄-C₂₅-mono- or -dicarboxylic acids and/or C₄-C₂₅-mono- or -diamines. Particular preference is given to using polyaspartic acids modified with C₆-C₂₂-mono- or -dicarboxylic acids or with C₆-C₂₂-mono- or -diamines produced in phosphorus-containing acids.

Condensation products of citric acid with hydroxycarboxylic acids or polyhydroxy compounds suitable as (B′) are known, for example, from WO-A 93/22362 and WO-A 92/16493. Such condensates comprising carboxyl groups usually have molecular masses up to 10 000, preferably up to 5000.

Further suitable as (B′) are ethylenediaminedisuccinic acid, oxydisuccinic acid, aminopolycarboxylates, aminopolyalkylene phosphonates and polyglutamates.

Furthermore, in addition to (B′), oxidized starches can be used as organic cobuilders.

### Surfactants

Besides the surfactant mixture according to the invention, further surfactants can be used.

Suitable inorganic surfactants (C) are, for example, fatty alcohol sulfates of fatty alcohols having 8 to 22, preferably 10 to 18, carbon atoms, e.g. C₉-C₁₁-alcohol sulfates, C₁₂-C₁₄-alcohol sulfates, cetyl sulfate, myristyl sulfate, palmityl sulfate, stearyl sulfate and tallow fatty alcohol sulfate.

Further suitable anionic surfactants are alkanesulfonates, such as C₈-C₂₄-, preferably C₁₀-C₁₈-alkylsulfonates, and soaps, such as, for example, the Na and K salts of C₈-C₂₄-carboxylic acids.

Further suitable anionic surfactants are C₉-C₂₀ linear alkylbenzenesulfonates (LAS) and C₉-C₂₀ linear alkyltoluenesulfonates.

Further suitable anionic surfactants (C) are also C₈-C₂₄-olefinsulfonates and -disulfonates, which can also constitute mixtures of alkene- and hydroxyalkanesulfonates or -disulfonates, alkyl ester sulfonates, sulfonated polycarboxylic acids, alkyl glyceryl sulfonates, fatty acid glycerol ester sulfonates, alkylphenol polyglycol ether sulfates, paraffinsulfonates having about 20 to about 50 carbon atoms (based on paraffin or paraffin mixtures obtained from natural sources), alkyl phosphates, acyl isethionates, acyl taurates, acyl methyl taurates, alkylsuccinic acids, alkenylsuccinic acids or half-esters or half-amides thereof, alkylsulfosuccinic acids or amides thereof, mono- and diesters of sulfosuccinic acids, acyl sarcosinates, sulfated alkyl polyglucosides, alkyl polyglycol carboxylates, and hydroxyalkyl sarcosinates.

The anionic surfactants are preferably added to the detergent in the form of salts. Suitable cations in these salts are alkali metal ions, such as sodium, potassium and lithium and ammonium salts, such as, for example, hydroxyethylammonium, di(hydroxyethyl)ammonium and tri(hydroxyethyl)ammonium salts.

Component (C) is present in the textile detergent formulation according to the invention preferably in an amount of from 3 to 30% by weight, in particular 5 to 20% by weight. If C₉-C₂₀ linear alkylbenzenesulfonates (LAS) are used, these are usually used in an amount up to 25% by weight, in particular up to 20% by weight. It is possible to use only one class of anionic surfactants on its own, for example only fatty alcohol sulfates or only alkylbenzenesulfonates, although it is also possible to use mixtures from different classes, e.g. a mixture of fatty alcohol sulfates and alkylbenzenesulfonates. Within the individual classes of anionic surfactants, mixtures of different species can also be used.

A further class of suitable surfactants to be mentioned are nonionic surfactants (D), in particular alkylphenol alkoxylates, such as alkylphenol ethoxylates with C₆-C₁₄-alkyl chains and 5 to 30 mol of alkylene oxide units.

Another class of nonionic surfactants are alkyl polyglucosides or hydroxyalkyl polyglucosides having 8 to 22, preferably 10 to 18, carbon atoms in the alkyl chain. These compounds comprise mostly 1 to 20, preferably 1.1 to 5, glucoside units. Another class of nonionic surfactants are N-alkylglucamides with C₆-C₂₂-alkyl chains. Compounds of this type are obtained, for example, by acylation of reductively aminated sugars with corresponding long-chain carboxylic acid derivatives.

Further suitable as nonionic surfactants (D) are also block copolymers of ethylene oxide, propylene oxide and/or butylene oxide (Pluronic and Tetronic grades from BASF), polyhydroxy or polyalkoxy fatty acid derivatives, such as polyhydroxy fatty acid amides, N-alkoxy- or N-aryloxy-polyhydroxy fatty acid amides, fatty acid amide ethoxylates, in particular terminally capped, and also fatty acid alkanolamide alkoxylates.

Component (D) is present in the textile detergent formulation according to the invention preferably in an amount of from 1 to 20% by weight, in particular 3 to 12% by weight. It is possible to use only one class of nonionic surfactants on its own, in particular only alkoxylated C₈-C₂₂-alcohols, but it is also possible to use mixtures from different classes. Within the individual classes of nonionic surfactants, mixtures of different species can also be used.

Since the balance between the specified types of surfactant is of importance for the effectiveness of the detergent formulation according to the invention, anionic surfactants (C) and nonionic surfactants (D) are preferably in the weight ratio from 95:5 to 20:80, in particular from 80:20 to 50:50. Here, the surfactant constituents of the surfactant mixture according to the invention should also be taken into consideration.

Furthermore, cationic surfactants (E) can also be present in the detergents according to the invention.

Suitable cationic surfactants are, for example, interface-active compounds comprising ammonium groups, such as, for example, alkyldimethylammonium halides and compounds of the general formula

RR′R″R′″N⁺X⁻

in which the radical R to R′″ are alkyl, aryl radicals, alkylalkoxy, arylalkoxy, hydroxyalkyl(alkoxy), hydroxyaryl(alkoxy) groups and X is a suitable anion.

The detergents according to the invention can, if appropriate, also comprise ampholytic surfactants (F), such as, for example, aliphatic derivatives of secondary or tertiary amines which comprise an anionic group in one of the side chains, alkyldimethylamine oxides or alkyl- or alkoxymethylamine oxides.

Components (E) and (F) can be present in the detergent formulation up to 25%, preferably 3-15%.

### Bleaches

In a further preferred embodiment, the textile detergent formulation according to the invention additionally comprises 0.5 to 30% by weight, in particular 5 to 27% by weight, especially 10 to 23% by weight, of bleaches (G). Examples are alkali metal perborates or alkali metal carbonate perhydrates, in particular the sodium salts.

One example of an organic peracid which can be used is peracetic acid, which is preferably used during commercial textile washing or commercial cleaning.

Bleach or textile detergent compositions to be used advantageously comprise C₁₋₁₂-percarboxylic acids, C₈₋₁₆-dipercarboxylic acids, imidopercaproic acids, or aryldipercaproic acids. Preferred examples of acids which can be used are peracetic acid, linear or branched octane-, nonane-, decane- or dodecanemonoperacids, decane- and dodecanediperacid, mono- and diperphthalic acids, -isophthalic acids and -terephthalic acids, phthalimidopercaproic acid and terephthaloyldipercaproic acid. It is likewise possible to use polymeric peracids, for example those which comprise acrylic acid basic building blocks in which a peroxy function is present. The percarboxylic acids can be used as free acids or as salts of the acids, preferably alkali metal or alkaline earth metal salts. These bleaches (G) are used, if appropriate, in combination with 0 to 15% by weight, preferably 0.1 to 15% by weight, in particular 0.5 to 8% by weight, of bleach activators (H). In the case of color detergents, the bleach (G) (if present) is usually used without bleach activator (H), otherwise bleach activators (H) are also usually present.

Suitable bleach activators (H) are:
polyacylated sugars, e.g. pentaacetylglucose;
acyloxybenzenesulfonic acids and alkali metal and alkaline earth metal salts thereof, e.g. sodium p-isononanoyloxybenzenesulfonate or sodium p-benzoyloxybenzenesulfonate;
N,N-diacetylated and N,N,N′,N′-tetraacylated amines, e.g. N,N,N′,N′-tetraacetylmethylenediamine and -ethylenediamine (TAED), N,N-diacetylaniline, N,N-diacetyl-p-toluidine or 1,3-diacylated hydantoins, such as 1,3-diacetyl-5,5-dimethylhydantoin;
N-alkyl-N-sulfonylcarboxamides, e.g. N-methyl-N-mesylacetamide or N-methylN-mesylbenzamide;
N-acylated cyclic hydrazides, acylated triazoles or urazoles, e.g. monoacetylmaleic acid hydrazide;
O,N,N-trisubstituted hydroxylamines, e.g. O-benzoyl-N,N-succinylhydroxylamine, O-acetyl-N,N-succinylhydroxylamine or O,N,N-triacetylhydroxylamine;
N,N′-diacylsulfurylamides, e.g. N,N′-dimethyl-N,N′-diacetylsulfurylamide or N,N′-diethyl-N,N′-dipropionylsulfurylamide;
triacyl cyanurates, e.g. triacetyl cyanurate or tribenzoyl cyanurate;
carboxylic anhydrides, e.g. benzoic acid anhydride, m-chlorobenzoic anhydride or phthalic anhydride;
1,3-diacyl-4,5-diacyloxyimidazolines, e.g. 1,3-diacetyl-4,5-diacetoxyimidazoline;
tetraacetylglycoluril and tetrapropionylglycoluril;
diacylated 2,5-diketopiperazines, e.g. 1,4-diacetyl-2,5-diketopiperazine;
acylation products of propylenediurea and 2,2-dimethylpropylenediurea, e.g. tetraacetylpropylenediurea;

α-acyloxypolyacylmalonamides, e.g. α-acetoxy-N,N′-diacetylmalonamide;
diacyldioxohexahydro-1,3,5-triazines, for example 1,5-diacetyl-2,4-dioxohexahydro-1,3,5-triazine;
benz(4H)-1,3-oxazin-4-ones with alkyl radicals, e.g. methyl, or aromatic radicals, e.g. phenyl, in the 2 position.

The described bleaching system of bleaches and bleach activators can, if appropriate, also comprise bleach catalysts. Suitable bleach catalysts are, for example, quaternized imines and sulfonimines, which are described, for example, in U.S. Pat. No. 5,360,569 and EP-A 0 453 003. Particularly effective bleach catalysts are manganese complexes which are described, for example, in WO-A 94/21777. In the case of their use in the detergent formulations, such compounds are incorporated at most in amounts up to 1.5% by weight, in particular up to 0.5% by weight.

Besides the described bleaching system of bleaches, bleach activators and, if appropriate, bleach catalysts, the use of systems with enzymatic peroxide release or of photoactivated bleach systems is also conceivable for the textile detergent formulation according to the invention.

### Enzymes

In a further preferred embodiment, the textile detergent formulation according to the invention additionally comprises 0.05 to 4% by weight of enzymes (J). Enzymes preferably used in detergents are proteases, amylases, lipases and cellulases. Of the enzymes, preferably amounts of 0.1-1.5% by weight, particularly preferably 0.2 to 1.0% by weight, of the formulated enzyme are added. Suitable proteases are, for example, savinase and esperase (manufacturer: Novo Nordisk). A suitable lipase is, for example, lipolase (manufacturer: Novo Nordisk). A suitable cellulase is, for example, celluzym (manufacturer: Novo Nordisk). The use of peroxidases for activating the bleaching system is also possible. It is possible to use individual enzymes or a combination of different enzymes. If appropriate, the textile detergent formulation according to the invention can also comprise enzyme stabilizers, e.g. calcium propionate, sodium formate or boric acids or salts thereof, and/or oxidation inhibitors.

### Further Ingredients

Besides the specified components, the formulation according to the invention can also comprise the following further customary additives in the amounts customary for this purpose:
Graying inhibitors and soil release polymers

Suitable soil release polymers and/or graying inhibitors for detergents are, for example:

polyesters of polyethylene oxides with ethylene glycol and/or propylene glycol and aromatic dicarboxylic acids or aromatic and aliphatic dicarboxylic acids;
polyesters of polyethylene oxides terminally capped at one end with di- and/or polyhydric alcohols and dicarboxylic acid.

Such polyesters are known, for example from U.S. Pat. No. 3,557,039, GB-A 1 154 730, EP-A 0 185 427, EP-A 0 241 984, EP-A 0 241 985, EP-A 0 272 033 and U.S. Pat. No. 5,142,020.

Further suitable soil release polymers are amphiphilic graft polymers or copolymers of vinyl esters and/or acrylic esters onto polyalkylene oxides (cf. U.S. Pat. No. 4,746,456, U.S. Pat. No. 4,846,995, DE-A 37 11 299, U.S. Pat. No. 4,904,408, U.S. Pat. No. 4,846,994 and U.S. Pat. No. 4,849,126) or modified celluloses, such as, for example, methylcellulose, hydroxypropylcellulose or carboxymethylcellulose.
color transfer inhibitors, for example homopolymers and copolymers of vinylpyrrolidone, of vinylimidazole, of vinyloxazolidone or of 4-vinylpyridine N-oxide having molar masses of from 15 000 to 100 000, and crosslinked finely divided polymers based on these monomers;
nonsurfactant-like foam suppressants or foam inhibitors, for example organopolysiloxanes and mixtures thereof with microfine, if appropriate silanized silica, and paraffins, waxes, microcrystalline waxes and mixtures thereof with silanized silica;
complexing agents (also in the function of organic cobuilders);
optical brighteners;
polyethylene glycols; polypropylene glycols
perfumes or fragrances;
fillers;
inorganic extenders, e.g. sodium sulfate,
formulation auxiliaries;
solubility improvers;
opacifiers and pearlizing agents;
dyes;
corrosion inhibitors;
peroxide stabilizers;
electrolytes.

The detergent formulation according to the invention is preferably solid, i.e. is usually in powder or granule form or in the form of an extrudate or tablet.

The powder- or granule-formed detergents according to the invention can comprise up to 60% by weight of inorganic extenders. Sodium sulfate is usually used for this purpose. Preferably, however, the detergents according to the invention have a low content of extenders and comprise only up to 20% by weight, particularly preferably only up to 8% by weight, of extenders, particularly in the case of compact or ultracompact detergents. The solid detergents according to the invention can have various bulk densities in the range from 300 to 1300 g/l, in particular from 550 to 1200 g/l. Modern compact detergents generally have high bulk densities and exhibit a granule structure. The methods customary in the art can be used for the desired compaction of the detergents.

The detergent formulation according to the invention can be produced by customary methods and, if appropriate, be formulated.

Typical compositions of compact standard detergents and color detergents are given below (the percentages refer, in the text below and also in the examples, to the weight; the data in brackets in the case of compositions (a) and (b) are preferred ranges):

### (a) Composition of Compact Standard Detergent (Powder or Granule Form)

1-60% (8-30%) of a surfactant mixture according to the invention and, if appropriate, at least one anionic surfactant (C) in combination with a nonionic surfactant (D)
5-50% (10-45%) of at least one inorganic builder (A)
0.1-20% (0.5-15%) of at least one organic cobuilder (B)
5-30% (10-25%) of an inorganic bleach (G)
0.1-15% (1-8%) of a bleach activator (H)
0-1% (at most 0.5%) of a bleach catalyst
0.05-5% (0.1-2.5%) of a color transfer inhibitor
0.3-1.5% of a soil release polymer
0.1-4% (0.2-2%) enzyme or enzyme mixture (J)

Further customary additives:

Sodium sulfate, complexing agent, phosphonates, optical brighteners, perfume oils, foam suppressants, graying inhibitors, bleach stabilizers

### (b) Composition of Color Detergent (Powder or Granule Form)

3-50% (8-30%) of a surfactant mixture according to the invention and, if appropriate, at least one anionic surfactant (C) in combination with a nonionic surfactant (D)
10-60% (20-55%) of at least one inorganic builder (A)
0-15% (0-5%) of an inorganic bleach (G)
0.05-5% (0.2-2.5%) of a color transfer inhibitor
0.1-20% (1-8%) of at least one organic cobuilder (B)
0.2-2% enzyme or enzyme mixture (J)
0.2-1.5% soil release polymer

Further customary additives:

Sodium sulfate, complexing agent, phosphonates, optical brighteners, perfume oils, foam suppressants, graying inhibitors, bleach stabilizers.

The invention is illustrated in more detail by reference to the examples below.

### EXAMPLES

### Example I

### Surfactant I

A mixture of 2-propylheptanol (2-PH) and 5-methyl-2-propylhexanol, which is sold as technical-grade 2-PH by BASF, as short-chain component (A) with an average degree of branching of 1.15 and as long-chain component (B) isoheptadecanol (i-C17OH) with an average degree of branching of approximately 3.1 are mixed in varying mass ratios (A:B=2-PH:i-C17OH) and then ethoxylated by means of KOH catalysis, during which differing degrees of ethoxylation are possible.

### Comparative Example 2

### Surfactant II

A mixture of 2-propylheptanol (2-PH) and 5-methyl-2-propylhexanol, which is sold as technical-grade 2-PH by BASF, as short-chain component (A) with an average degree of branching of 1.15 and as long-chain component (B) tallow fatty alcohol (C16-C18 OH) with an average degree of branching of approximately 0 are mixed in various mass ratios (A:B=2-PH:i-C16-C18-OH) and then ethoxylated by means of KOH catalysis, during which varying degrees of ethoxylation are possible.

### Comparative Example 3

### Surfactant III

A mixture of 2-propylheptanol (2-PH) and 5-methyl-2-propylhexanol, which is sold as technical-grade 2-PH by BASF, is ethoxylated by means of KOH catalysis, during which varying degrees of ethoxylation are possible. Isotridecanol is ethoxylated by means of KOH catalysis, during which varying degrees of ethoxylation are possible. The ethoxylates are mixed in different ratios.

Alternatively, a mixture of 2-propylheptanol (2-PH) and 5-methyl-2-propylhexanol, which is sold as technical-grade 2-PH by BASF, as short-chain component (A) with an average degree of branching of 1.15 and isotridecanol (i-C130H) with an average degree of branching of approximately 3 is mixed in various mass ratios (A:B=2-PH:i-C13-OH) and then ethoxylated by means of KOH catalysis, during which varying degrees of ethoxylation are possible.

### Example 4

### Wetting of Cotton According to DIN EN 1772

The tables below show wetting times according to EN 1772, 2 g/l soda of the surfactant I according to the invention and also of the reference mixture surfactant I.

| | 4:6 | 5:5 |
|---|---|---|
| Surfactant I 7 mol EO | 20 s | 27 s |
| Surfactant II 7 mol EO | 38 s | 43 s |

Summary: Better wetting powers are found for surfactant I

### Example 5

### Foaming Ability

The tables below show the determination of the foaming ability—perfluorinated disk beating method [DIN EN 12728, 2 g/l, 40° C.] of the surfactant I according to the invention and also of the reference mixture surfactant II.

| | 5:5 |
|---|---|
| Surfactant I 7 mol EO | 200 ml |
| Surfactant II 7 mol EO | 260 ml |

Summary: Better wetting powers are found for surfactant I

### Example 6

### Detergency

The washing conditions are given in table 1. The detergent formulation is listed in table 2.

TABLE 1
Washing conditions

| | |
|---|---|
| Washing device | Launderometer from Atlas, Chicago, USA |
| Washing cycles | 1 per type of soiled fabric |
| Rinse cycles | 1 |
| Washing temperature | 25° C. and 60° C. |
| Washing time | 30 min. (including heating time) |
| Water hardness | 2.5 mmol/l (14° German hardness) |
| Ca:Mg | 4:1 |
| Liquor amount | 250 ml |
| Liquor ratio | 1:12.5 |
| Detergent concentration | 5 g/l |
| Soiled fabric | wfk 10 D pigment/skin grease on cotton |
| | wfk 10 PF pigment/plant grease on cotton |
| | Test fabrics from wfk-Testgewebe GmbH, |
| | Christenfeld 10, D-41379 Brüggen |
| | Triolein on cotton |
| | Olive oil on cotton |
| | Our own soilings: |
| | 0.1 g of oil (dyed with 0.1% Sudan Red 7B) |
| | is dripped onto cotton fabric and stored at |
| | room temperature for 20 hours. |

After rinsing, spinning was carried out and the fabric was hung up to dry individually. To ascertain the primary detergency, the degree of whiteness of the soiled fabric is measured before and after washing using a photometer (Elrepho) from Datacolor AG, CH-8305 Dietikon, Switzerland.

The reflectance values are determined at 460 nm (wfk 10D, wfk 10 PF) and 520 nm (Triolein/cotton and olive oil/cotton), with 6 measurement points per soiling type being averaged in each case.

The primary detergency is given as % detergency, which is calculated from the measured reflectance values according to the following formula:

Detergency %=100% [reflectance surfactant A, B or C]−reflectance [without surfactant]/[reflectance Lutensol AO7]−[reflectance [without surfactants]]

Better soil removal is indicated by higher detergency.

TABLE 2
Detergent formulation (data in % by wt.)

| | |
|---|---|
| Potassium coconut soap | 0.5% |
| Zeolite A | 30% |
| Sodium carbonate | 12% |
| Sodium metasilicate x 5.5 water | 3% |
| Sodium percarbonate | 15% |
| Tetraacetylethylenediamine (TAED) | 4% |
| Sokalan ® CP 5 | 5% |
| Carboxymethylcellulose (CMC) | 1.2% |
| Sodium sulfate | 4% |
| Surfactant according to the invention | 5% |
| Water | 20.3% |

### Washing at 25° C.

### Reflectances of the References

| | Nonionic surfactant | | | | |
|---|---|---|---|---|---|
| | | | | | Average |
| | WFK 10D | WFK 10PF | Triolein | Olive oil | value |
| Without | 50.7 | 38.9 | 41.2 | 39.2 | 39.5 |
| Lutensol | 55.5 | 49.6 | 50.4 | 50.8 | 46.6 |
| AO7 | | | | | |

Detergency %=100% [reflectance surfactant I, II or III]−reflectance [without surfactants]/[reflectance Lutensol AO7]−[reflectance [without surfactants]]

| | alcohol | | | | | |
|---|---|---|---|---|---|---|
| Nonionic | ratio | WFK | WFK | | Olive | Average |
| surfactant | (B:A) | 10D | 10PF | Triolein | oil | value |
| Surfactant I | 50:50 | 133% | 103% | 131% | 134% | 125% |
| 7 mol EO | | | | | | |
| Surfactant I | 40:60 | 101% | 83% | 109% | 117% | 103% |
| 7 mol EO | | | | | | |
| Surfactant II | 50:50 | 57% | 38% | 116% | 137% | 87% |
| 7 mol EO | | | | | | |
| Surfactant II | 60:40 | 63% | 49% | 109% | 137% | 89% |
| 7 mol EO | | | | | | |
| Surfactant III | 50:50 | 86% | 99% | 90% | 108% | 96% |
| 7 mol EO | | | | | | |

### Washing at 60° C.

### Reflectances of the References

| | Nonionic surfactant | | | | |
|---|---|---|---|---|---|
| | | | | | Average |
| | WFK 10D | WFK 10PF | Triolein | Olive oil | value |
| Without | 49.26 | 42.72 | 46.49 | 48.13 | 45.1 |
| Lutensol | 66.13 | 61.25 | 58.62 | 60.45 | 58.8 |
| AO7 | | | | | |

Detergency %=100% [reflectance surfactant I, II or III]−reflectance [without surfactants]/[reflectance Lutensol AO7]−[reflectance [without surfactants]]

| | alcohol | | | | | |
|---|---|---|---|---|---|---|
| Nonionic | ratio | WFK | WFK | | Olive | Average |
| surfactant | (B:A) | 10D | 10PF | Triolein | oil | value |
| Surfactant I | 50:50 | 90.7% | 81.2% | 98.8% | 102.8% | 93.4% |
| 7 mol EO | | | | | | |
| Surfactant I | 40:60 | 93.0% | 83.8% | 94.3% | 88.8% | 90.0% |
| 7 mol EO | | | | | | |
| Surfactant II | 50:50 | 83.7% | 7.2% | 94.2% | 68.4% | 63.4% |
| 7 mol EO | | | | | | |
| Surfactant II | 60:40 | 66.1% | 34.8% | 86.7% | 84.2% | 68.0% |
| 7 mol EO | | | | | | |
| Surfactant III | 50:50 | 85.3% | 87.5% | 118.4% | 80.7% | 93.0% |
| 7 mol EO | | | | | | |

### Summary:

Surfactant I is superior to the comparative examples in domestic washing and to standard surfactants (e.g. C13,15 oxo alcohol×7 EO, Lutensol AO7) at low temperatures.

### Example 7

Surfactant I was examined according to the actual OECD 301 B method (status 17.07.1992)

| | alcohol ratio A:B | mol EO | biodegradation after 28 days |
|---|---|---|---|
| Surfactant 1 | 60:40 | 7 | >60% (70-80%) |
| Surfactant 1 | 60:40 | 5 | >60% (60-70%) |

Summary: The claimed surfactant mixtures have to be classified as completely biodegradable according to OECD method 301 B (status 17.07.1992).

1. A surfactant mixture comprising
(A) a short-chain component comprising the alkoxylation product of alkanols, where the alkanols have 8 to 12 carbon atoms and the average number of alkoxy groups per alkanol group in the alkoxylation product assumes a value from 0.1 to 30, the alkoxy groups are C₂₋₁₀-alkoxy groups and the alkanols have an average degree of branching of at least 1; and
(B) a long-chain component comprising the alkoxylation product of alkanols, where the alkanols have 15 to 19 carbon atoms and the average number of alkoxy groups per alkanol group in the alkoxylation product assumes a value from 0.1 to 30, the alkoxy groups are C₂₋₁₀-alkoxy groups and the alkanols have an average degree of branching of at least 2.5;
and/or phosphate esters, sulfate esters and ether carboxylates thereof.

2. The surfactant mixture according to claim 1, wherein the alkoxy groups are selected independently from the group consisting of ethoxy, propoxy, butoxy and pentoxy groups.

3. The surfactant mixture according to claim 1, wherein for the short-chain component (A) and/or the long-chain component (B), the fraction of ethoxy groups to the total number of alkoxy groups for the particular alkoxylation product is at least 0.5.

4. The surfactant mixture according to claim 1, wherein the at least one alkanol of the short-chain component (A) has 9 to 11 carbon atoms.

5. The surfactant mixture according to claim 1, wherein the at least one alkanol of the short-chain component (A) has an average degree of branching of from 1.0 to 2.0.

6. The surfactant mixture according to claim 1, wherein the at least one alkanol of the long-chain component (B) has 16 to 18 carbon atoms.

7. The surfactant mixture according to claim 1, wherein the at least one alkanol of the long-chain component (B) has an average degree of branching of from 2.5 to 4.0.

8. The surfactant mixture according to claim 1, wherein the average number of alkoxy groups per alkanol group in the alkoxylation product for component (A) and/or (B) assumes as value of from 1 to 30.

9. The surfactant mixture according to claim 1, wherein the ratio of the molar fraction of the short-chain component (A) in the surfactant mixture to the molar fraction of the long-chain component (B) in the surfactant mixture assumes a value in the range from 99:1 to 1:99.

10. A formulation comprising a surfactant mixture according to claim 1.

11. A method of producing a surfactant mixture according to claim 1, comprising
(a) alkoxylating an alkanol mixture, where the alkanol mixture has 8 to 12 carbon atoms, the average number of alkoxy groups per alkanol group in the alkoxylation product assumes a value from 0.1 to 30, the alkoxy groups are C₂₋₁₀-alkoxy groups and the alkanol mixture has an average degree of branching of at least 1;
(b) alkoxylating an alkanol mixture, where the alkanol mixture has 15 to 19 carbon atoms, the average number of alkoxy groups per alkanol group in the alkoxylation product assumes a value from 0.1 to 30, the alkoxy groups are C₂₋₁₀-alkoxy groups and the alkanol mixture has an average degree of branching of at least 2.5; and
(c) mixing the alkoxylation products obtained in step (a) and (b).

12. A method of producing a surfactant mixture according to claim 1, comprising the steps
(a) mixing a first alkanol mixture, which has 8 to 12 carbon atoms and an average degree of branching of at least 1, with at least a second alkanol mixture, which has 15 to 19 carbon atoms and an average degree of branching of at least 2.5; and
(b) alkoxylating of the mixture of the first and second mixture, where the number of alkoxy groups per alkanol group in the alkoxylation product assumes an average value of from 0.1 to 30 and the alkoxy groups are C₂₋₁₀-alkoxy groups.

13. A method of using a surfactant mixture according to claim 1 as emulsifier, foam regulator, wetting agent, or humectant.

14. (canceled)
